(19) United States
(12) Patent Application Publication
(10) Pub. No.: US 2007/0221695 A1
(43) Pub. Date: Sep. 27, 2007

(54) Vehicle mountable refuse container transport device

(76) Inventor: Robert Brian Winkler, Bayfield, CO (US)

Correspondence Address: ROBERT BRIAN WINKLER, 658 N. WINDY RIDGE RD., BAYFIELD, CO, 81122, US

(21) Appl. No.: 11/277,066

(22) Filed: Mar. 21, 2006

(51) Int. Cl. B60R 11/00; B60R 9/00

(52) U.S. Cl. 224/519; 224/511

(57) ABSTRACT

Vehicle mountable refuse container transport device consisting of a carrier component that attaches to a refuse container, and a receiver component that attaches to a vehicle. When coupled, the carrier and receiver act together to hold the refuse container off the ground during transport.

### 1. FIELD OF THE INVENTION

This invention relates generally to the field of trash hauling and, more particularly, to a device mountable on a standard trailer hitch receiver or vehicle bumper for transporting standardized residential refuse containers.

### 2. BACKGROUND OF THE INVENTION

Automation of collection devices for refuse containers is employed in many locations. Container manufacturers have developed standardized refuse containers that employ an integrated attachment recess and lifting bar. The containers are typically constructed of high impact polyethylene or other plastic. The attachment recess is molded into one side of the container with a horizontal lifting bar mounted in the recess. A vertical tine on a lifting arm mounted to the refuse collection truck is inserted into the recess and engages the lifting bar for semi-automatic hoisting of the container in an arc to dump the container into the refuse bin on the truck chassis.

However, many collection companies use fully automated equipment that does not make use of the lifting bar and recess lip. Instead, they use a wrap around device that lifts the container over the truck and tips its contents into the truck's refuse bin. In that scenario, the recess and lifting bar of the container are not used for collection and are available for attaching a carrier device that will work in conjunction with a separate receiving device on a vehicle.

Refuse company customers in rural areas are required to deliver the loaded containers to pre-designated pickup locations. Frequently, the pickup locations are a considerable distance from the customers' residences and businesses.

Although most containers have integral wheels, the wheels are not sufficiently durable or properly positioned for moving the containers any distance, whether by a person or towed by a vehicle.

The containers have no provision for attaching to vehicles for the purpose of towing.

The containers are frequently of a size larger than can be fitted into ordinary passenger vehicles. If the user of such a container has a large enough vehicle, considerable space must be cleared within its cargo compartment each time the container is transported. Dirt, mud, snow & moisture are transferred from the container's wheels and bottom surface to the vehicle's cargo compartment. The cargo compartment may smell of trash during and after transport.

Many of the refuse companies' customers purchase pickup trucks, SUVs and the like due to the necessity of transporting the refuse containers to and from the pickup location. The containers are typically dropped off at the pickup location in the morning en route to the customers' places of employment, and are picked up as they return to their residences.

Others leave their assigned containers at the pickup location. They haul their trash within their vehicles and deposit it in the containers. Some store their trash at their residences or businesses until pickup day, and others deposit regularly between pickup days. These parked containers are unsightly and their presence impedes snow removal and road maintenance equipment. They also attract animals such as raccoons and bears. Garbage-fed wildlife may become dangerous to humans, necessitating the killing of animals.

Other inventors have designed devices that, when on a vehicle, impede access to its storage compartment and complicate parking the vehicle. If removed between drop off and pick up, the devices require nearly as much cargo space within a vehicle as a refuse container would. They are neither light nor compact.

It is therefore desirable to provide a device for vehicular transport of refuse containers that does not require the adding or removing of parts (other than the initial installation), does not materially alter the refuse container, does not interfere with or damage automated pickup equipment, does not require any space inside a vehicle, and does not impede the usefulness of the transport vehicle between drop off and pickup of the container.

### 3. BRIEF DESCRIPTION OF THE DRAWINGS

FIG. 1 is a front view of a typical refuse container with which the present invention will be employed;

FIG. 2 is an isometric view of the carrier component of the device;

FIG. 3 is an isometric view of the receiver component of the device as designed to work with a standard vehicle hitch receiver;

FIG. 4 is an isometric view of the receiver component of the device as designed to work with a standard pickup truck bumper;

FIG. 5 is an isometric view of the carrier and receiver components coupled;

FIG. 6 is a front view of the carrier and receiver components coupled;

FIG. 7 is a partial, cutaway side view detailing the latch mechanism;

FIG. 8 is a front view of the carrier component affixed to a refuse container;

FIG. 9 is a cutaway, side view of the refuse container being attached to a vehicle by means of the carrier and receiver components;

FIG. 10 is a cutaway, side view of the refuse container attached to a vehicle for transport by means of the carrier and receiver components.

### 4. DETAILED DESCRIPTION OF THE INVENTION

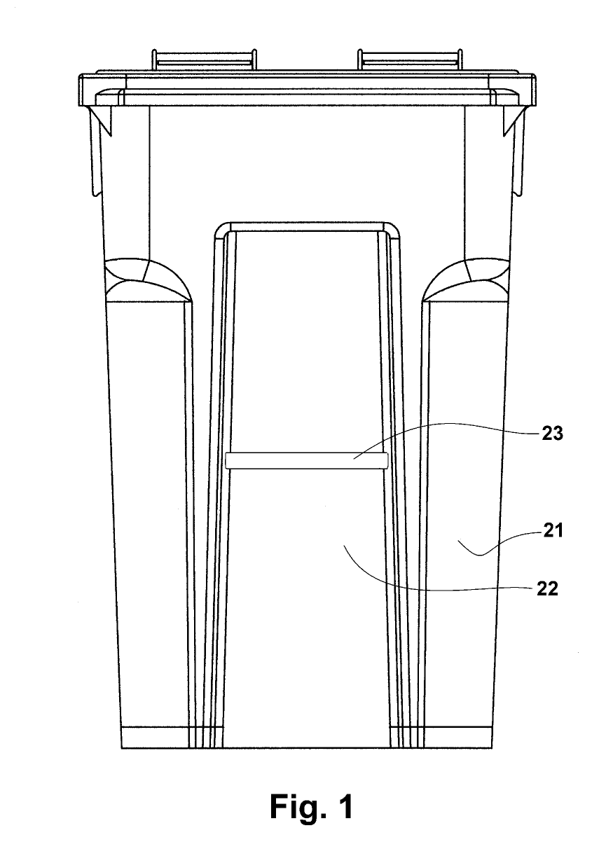

Turning to the drawings, FIG. 1 shows a refuse container 21 typical of the type to be used with the present invention. The container has a molded body with a recessed area 22. The recess is employed for attachment to semi-automated dumping equipment present on some refuse collection trucks using a lip along the upper periphery and a lifting bar 23 that spans the recess.

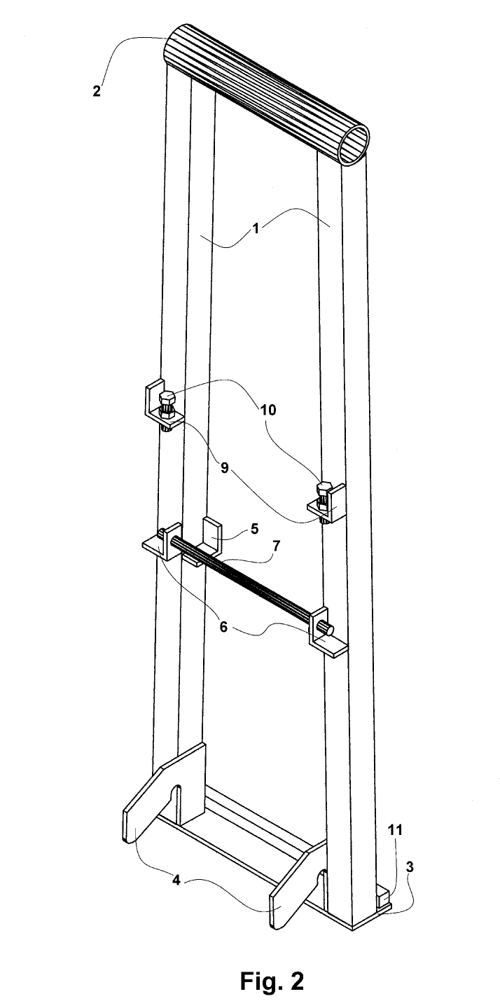

An embodiment of the carrier component of the present invention is shown in FIG. 2. A frame constructed of uprights 1, spanner 2 and a flat bottom plate 3 is sized to fit within the recessed area of a refuse container.

Hooks 4 are joined to the frame near the bottom. These hooks will engage the bottom rod of the receiver component (not shown) which is described below.

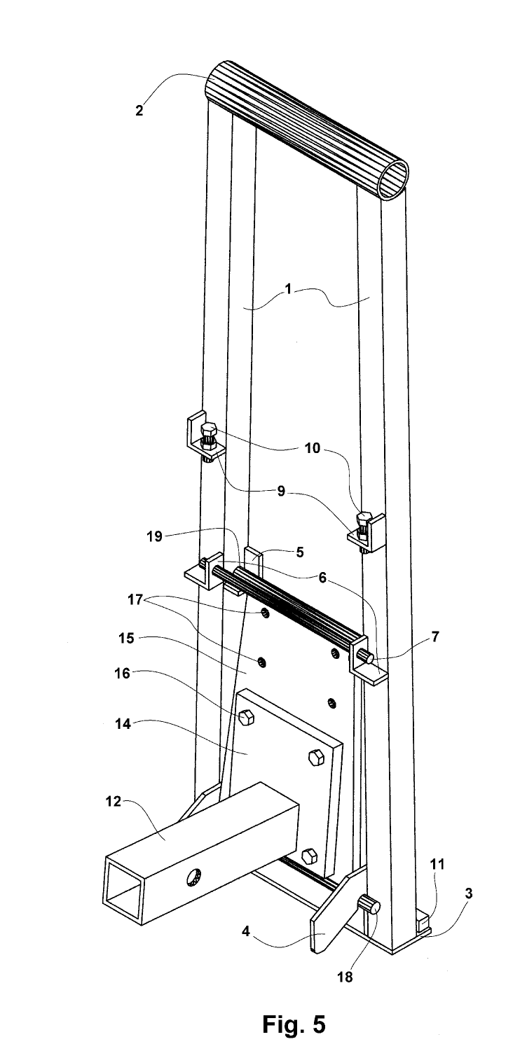

Receiver stops 5 are positioned inside the frame vertically up from the hooks 4. Their use is explained under the description of FIG. 5.

Latch brackets 6 are positioned to hold the latch rod 7 such that the top rod of the receiver (not shown) will pass between the latch rod 7 and the top plane of the horizontal surface of the receiver stops 5.

When the carrier component is affixed to a refuse container (not shown), the bottom plate 3 extends under the lower front edge of the container. Some container models have a molded ridge along the lower front edge. In that case, an appropriately sized rod 11 may be joined to the bottom plate 3, spaced such that the ridge of the container will fit between the rod 11 and the frame uprights 1. This simply reduces movement between the carrier and the container during use.

In the preferred embodiment the uprights are fabricated from square steel tubing, or other suitable material, and the other frame and carrier components are joined to them by welding.

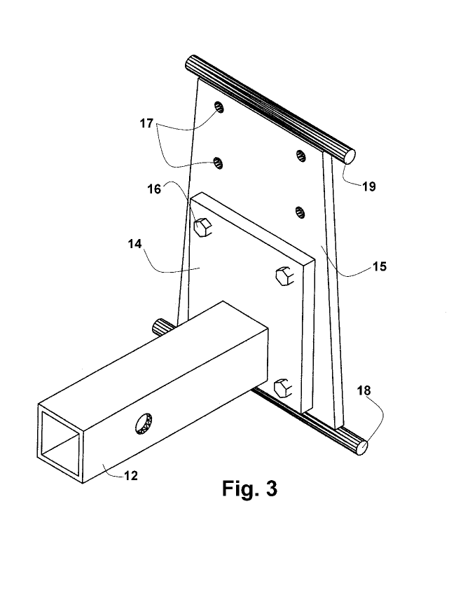

FIG. 3 shows a first embodiment of the receiver component of the present invention. A metal tube 12 sized to fit a standard vehicle receiver hitch is joined perpendicular and offset from vertical center to a metal hitch plate 14. The offset position allows for adjustments in ground clearance by rotating the assembly 180 degrees.

The hitch plate 14 has holes in each of four corners for bolting 16 to the receiver plate 15.

The receiver plate 15 has a plurality of holes 17 to accept the four bolts 16 of the hitch plate 14. These holes allow for additional adjustments to ground clearance.

Joined to the bottom edge of the receiver plate 15 is a bottom rod 18. A shorter, top rod 19 is joined to the top edge of the receiver plate 15.

In the preferred embodiment the components are fabricated from steel and are joined together by welding.

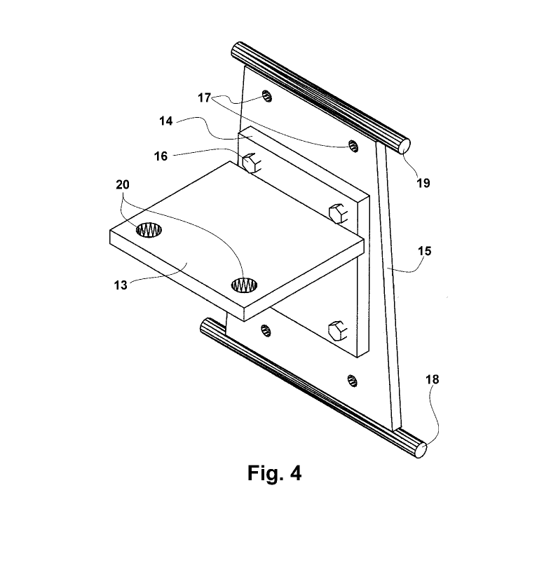

FIG. 4 shows a second embodiment of the receiver component. It is like the first embodiment in all respects except that the metal tube 12 in FIG. 3 is replaced by a flat bumper plate 13. Holes 20 in the bumper plate 13 are spaced to fit holes already in standard pickup truck bumpers (not shown). The assembly is bolted to the bumper.

FIG. 4, when compared with FIG. 3, illustrates ground clearance adjustability by rotating the hitch plate 14, and using other holes 17 in the receiver plate 15.

FIG. 5 shows the receiver and carrier components of the present invention coupled as they would be when transporting a refuse container (not shown).

The hooks 4 engage the bottom rod 18 of the receiver plate 15.

The top rod 19 of the receiver plate 15 rests within the angle of the receiver stops 5. The vertical plane of the stops 5 prevents the top rod of the receiver 19 from contacting the container (not shown). The horizontal plane of the stops 5 holds the top rod of the receiver 19 to prevent the receiver assembly from moving vertically and becoming disengaged from the hooks 4.

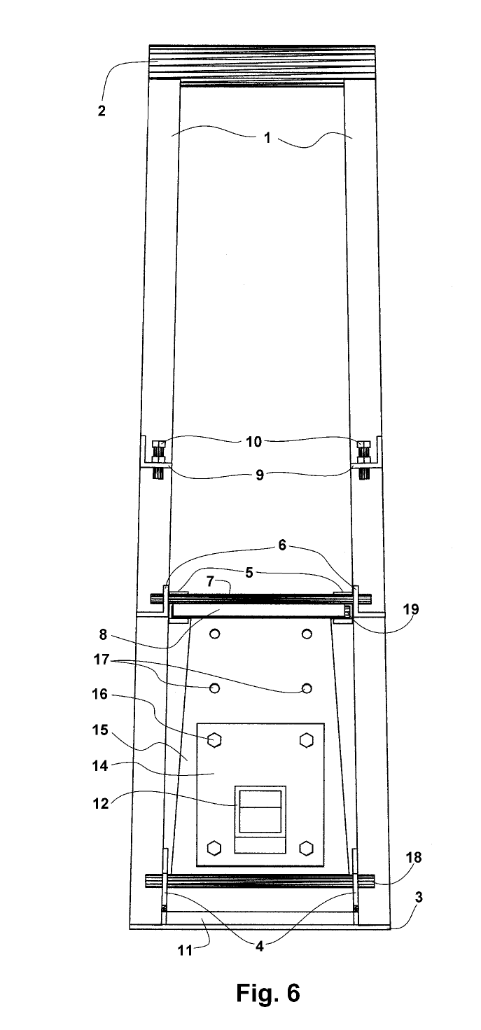

FIG. 6 is another view of the receiver and carrier components coupled. A latch plate 8 is joined to the latch rod 7.

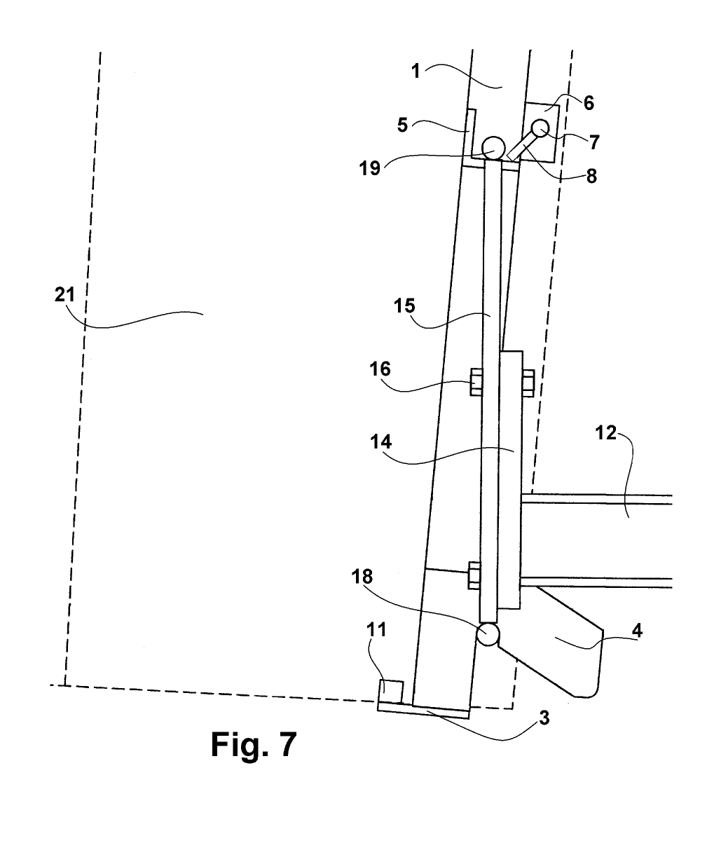

FIG. 7 is a cutaway side view of the latch mechanism that shows the relationship. During coupling, the latch plate 8 is pushed upward as the top rod 19 of the receiver plate 15 passes under it. The latch rod 7 swivels within the holes of the latch brackets 6. After the top rod 19 of the receiver plate 15 has completely passed clear of the latch plate 8, gravity causes the latch plate 8 to drop against the top horizontal plane of the receiver stops 5. Thus wedged, the receiver and carrier components remain securely coupled until the latch plate 8 is lifted.

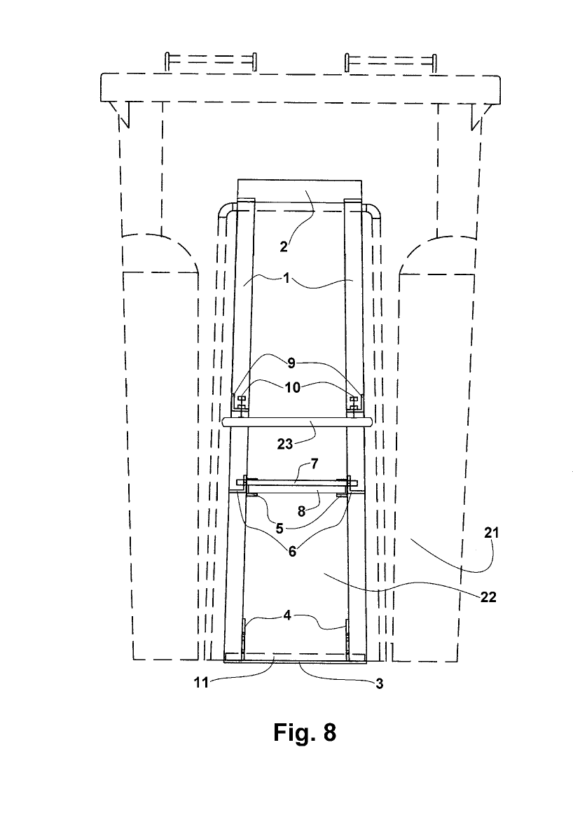

FIG. 8 shows the carrier component affixed within the recessed area 22 of a refuse container 21. The spanner 2 fits within a lip at the upper periphery of the recessed area 22. The bottom plate 3, in conjunction with the spanner 2 and uprights 1, supports the weight of the container 21. Movement is prevented by turning bolts 10 mounted to restraint brackets 9 against a restraining bar 23.

The restraining bar 23 is common to refuse containers for use as a lifting bar with truck mounted pickup equipment. When of sufficient strength, the existing lifting bar can be used as a restraining bar 23. Otherwise, it is replaced with stronger material.

Some refuse containers have molded lifting bars that cannot be removed. In those cases, the restraint brackets 9 and bolts 10 are replaced with appropriately sized clamps or other means to secure the carrier uprights 1 to the restraining bar 23.

In the case of refuse containers that do not have a lifting bar, a restraining bar 23 can be added. The exact procedure is dependent on the container design.

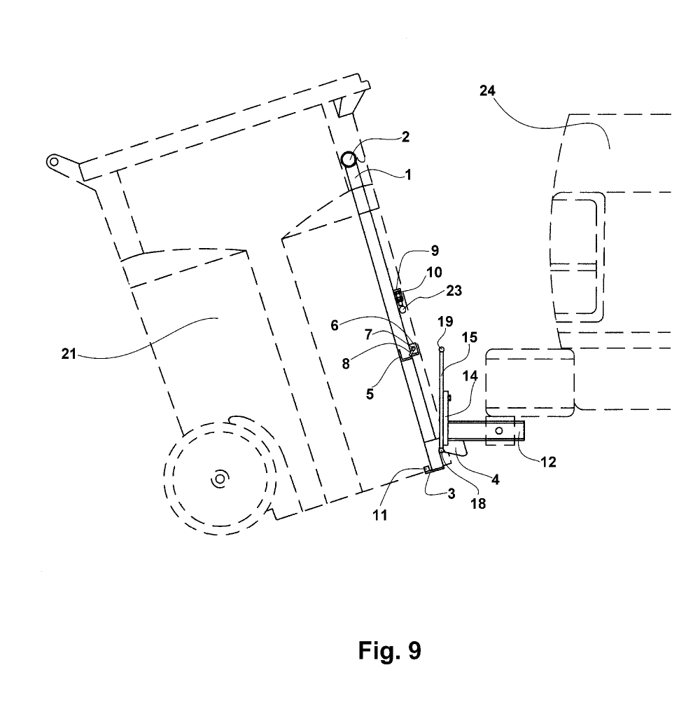

Operation of the invention is illustrated in FIG. 9. The container 21, with the carrier component of the present invention affixed, is rolled along the ground to the proximity of the transport vehicle 24, which has the receiver component of the present invention affixed to its hitch or bumper. The container 21 is tilted away from the vehicle 24 at an angle sufficient for the hooks 4 to align with the bottom rod 18 of the receiver plate 15.

When aligned, the container 21 is tilted toward the vehicle 24. The hooks 4 slip over the bottom rod 18. As the operator continues to tilt the container 21 toward the vehicle 24, the hooks 4 swivel on the bottom rod 18, and the container wheels lift off the ground.

The operator continues to tilt the container 21 toward the vehicle 24 until the top rod 19 contacts the receiver stops 5. At that point, the latch plate 8 drops against the top surface of the horizontal plane of the receiver stops 5.

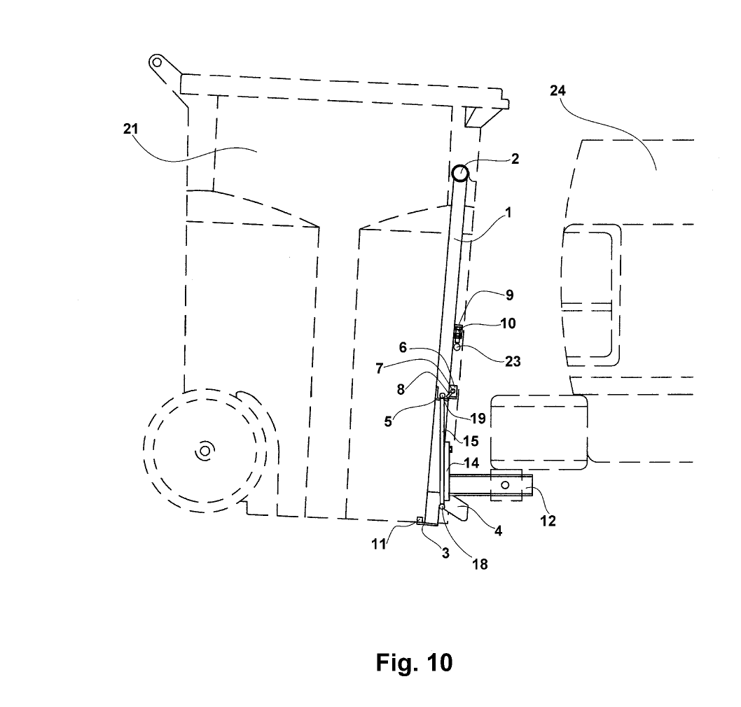

The operator then allows the container 21 to begin to tilt away from the vehicle 24. The top rod 19 comes in contact with the latch plate 8, pushing the latch plate 8 firmly against the receiver stops 5. Until the latch plate 8 is lifted, the receiver and carrier components of the present invention work together to hold the container 21 off the ground, as is shown in FIG. 10.

Of course, the transport device can be adapted to fit other brands of refuse containers (not shown) with modification to the dimensions and restraint system. Such modifications to fit specific refuse containers are considered to be within the scope and intended purpose of the present invention.

Key features of the carrier component can be incorporated into the design and structure of yet to be manufactured refuse containers. Such modifications to container design and structure are considered to be within the scope and intended purpose of the present invention.

Furthermore, the receiver component can be adapted to mount on vehicle components other than hitches and bumpers. Such modifications to fit specific transport vehicles are also considered to be within the scope and intended purpose of the present invention.

The present invention may be carried out in other ways than those herein set forth without departing from the spirit and essential characteristics of such invention. The present embodiments are, therefore, to be considered in all respects as illustrative and not restrictive. Those skilled in the art will recognize modifications and substitutions to the specific embodiments disclosed herein. All changes coming within the meaning and equivalency range of the appended claims are intended to be embraced therein.

What is claimed is:

1. A vehicle mountable refuse container transport device comprised of receiver and carrier components
a receiver component for mounting in a standard hitch receiver on a vehicle or bolting to a vehicle bumper comprising:
a square stub in the case of use with a vehicle receiver hitch, or a plate in the case of common pickup truck bumper attachment, horizontal to the ground plane when mounted on a vehicle;
a vertical element attached to the square stub or plate;
horizontal elements attached at the top and bottom of the vertical element parallel to the vehicle bumper;
a carrier component received by the receiver component comprising:
a vertical frame that fits the recessed area of a refuse container;
means of restraint to hold the frame within the container recess;
hooks for matching the carrier component to the receiver component such that the refuse container will be held off the ground during transport;
means for latching the carrier to the receiver during transport.

2. A vehicle mountable refuse container transport device as defined in claim 1 wherein the carrier component has a frame sized to fit within a recessed portion of the refuse container and securely engage features of the refuse container such that the carrier will not become separated from the container during transport.

3. A vehicle mountable refuse container transport device as defined in claim 1 wherein the receiver component can be left on the vehicle between uses without hindering parking of the vehicle or access to the storage area of the vehicle, and the carrier component can be permanently left on the refuse container without hindering the refuse companies' automated pickup equipment.
